(19) United States
(12) Patent Application Publication
(10) Pub. No.: US 2005/0108687 A1
(43) Pub. Date: May 19, 2005

(54) Context and content sensitive distributed application acceleration framework

(76) Inventors: Highland Mary Mountain, Gilbert, AZ (US); Krishnamurthy Srinivasan, Chandler, AZ (US); Kevin Brinkley, Portland, OR (US); Jackson He, Portland, OR (US)

Correspondence Address: Blakely, Sokoloff, Taylor & Zafman LLP, Suite 101, 5285 S.W. Meadows Road, Lake Oswego, OR, 97035, US

(21) Appl. No.: 10/716,695

(22) Filed: Nov. 18, 2003

(51) Int. Cl. G06F 9/44

(52) U.S. Cl. 717/127; 717/151; 717/104

(57) ABSTRACT

The present disclosure relates to the attempted acceleration and optimization of a distributed application, and, more specifically, to the attempted acceleration and optimization of a distributed application utilizing an end-to-end context and/or content sensitive framework.

### BACKGROUND

1. Field

The present disclosure relates to the attempted acceleration and optimization of a distributed application, and, more specifically, to the attempted acceleration and optimization of a distributed application utilizing an end-to-end context and/or content sensitive framework.

2. Background Information

In this context a distributed application is an application of components that typically runs in separate runtime environments, usually on different platforms connected by a network. Typical distributed applications may be characterized as: two-tier (client-server), three-tier (client-middleware-server), and n-tier (client-multiple middleware-multiple servers).

It is occasionally desirable to alter the performance of a distributed application to reflect the environment (e.g. platform, network, etc.) in which the application in being executed. Typically, the performance of a distributed application may be configured in a generic and static fashion. For example, a distributed application may be statically configured to provide rich audio and video content if the application is executed on a desktop computer. Conversely, the application may be configured to provide more rudimentary audio and video content if the application is executed, for example, on a hand-held device, such as a mobile phone. By tailoring the execution and content provided by the application to the execution environment, the speed and general performance of the application may be improved.

Such a static and generic configuration scheme provides a first-order approximation necessary to optimize and accelerate the distributed application. However, the typical optimization scheme is unable to adapt to changes in the execution environment of the distributed application and is only capable of dealing with the limited number of scenarios statically configured into the system.

### BRIEF DESCRIPTION OF THE DRAWINGS

Subject matter is particularly pointed out and distinctly claimed in the concluding portions of the specification. The disclosed subject matter, however, both as to organization and the method of operation, together with objects, features and advantages thereof, may be best understood by a reference to the following detailed description when read with the accompanying drawings in which:

FIG. 1 is a flowchart illustrating an embodiment of a technique for the attempted optimization of a distributed application in accordance with the disclosed subject matter;

FIG. 2 is a flowchart illustrating an embodiment of a technique for the creation of a device and environment database in accordance with the disclosed subject matter;

FIG. 3 is a flowchart illustrating an embodiment of a technique for the creation of an application characterization database in accordance with the disclosed subject matter;

FIG. 4 is a block diagram illustrating an embodiment of a system that allows for the attempted optimization of a distributed application in accordance with the disclosed subject matter; and

FIG. 5 is a block diagram illustrating an embodiment of an apparatus and a system that allows for the attempted optimization of a distributed application in accordance with the disclosed subject matter.

### DETAILED DESCRIPTION

In the following detailed description, numerous details are set forth in order to provide a thorough understanding of the present disclosed subject matter. However, it will be understood by those skilled in the art that the disclosed subject matter may be practiced without these specific details. In other instances, well-known methods, procedures, components, and circuits have not been described in detail so as to not obscure the disclosed subject matter.

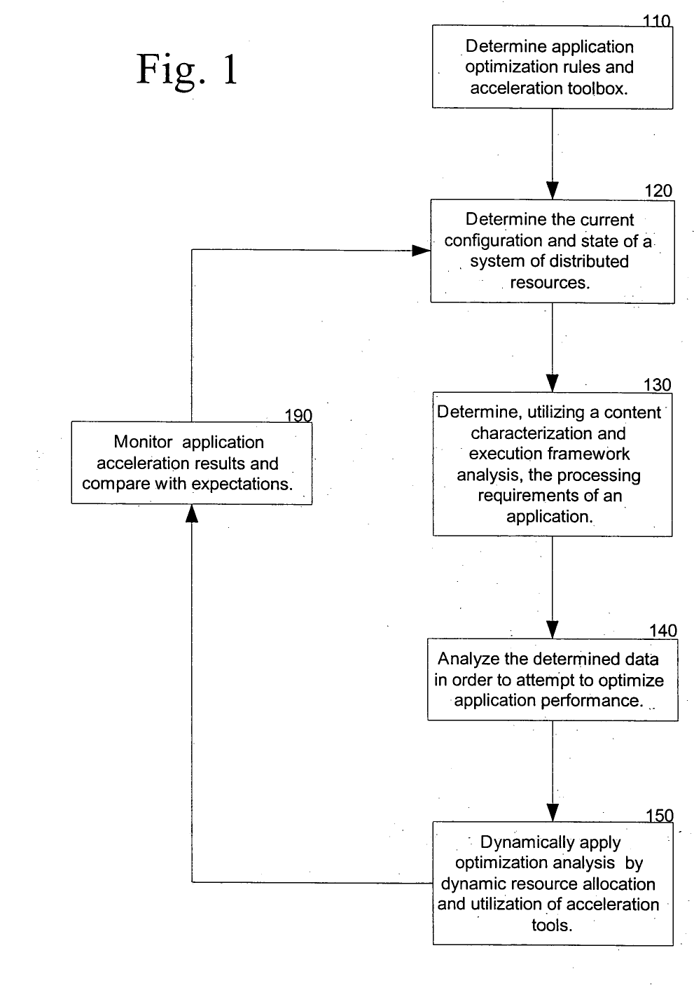

FIG. 1 is a flowchart illustrating an embodiment of a technique for the attempted optimization of a distributed application in accordance with the disclosed subject matter. Block 110 illustrates that the application optimization rules and acceleration toolbox may be determined. In one embodiment, an accelerator may access a group of statically configured rules that detail what forms of optimization may be attempted. In a specific example, an application may be configured to, for example, only attempt to optimize video performance by dropping frames from a transmission. In other examples, the application may be allowed to cache the video transmission, reduce the video frame size, or increase the compression of the video. These however, are a few illustrative examples. In one embodiment, the acceleration toolbox may include a set of, for example, dynamic libraries. One embodiment may include a primitive performance library that is optimized to the specific execution platforms. Such a library may include pre-compiled and optimized code that has been hand tuned to increase performance compared to normal libraries. One specific embodiment may include the Intel Primitive Performance (IPP) libraries. However, this is merely one specific non-limiting embodiment and other embodiments may include other acceleration toolboxes.

Block 120 illustrates that the current configuration and state of the system of resource or platforms may be determined. In one embodiment, a system of resources may include heterogeneous platforms, such as, for example, different processing units, processing architectures, chipsets, peripheral components, operating systems, web service consumers or providers, intermediary devices, wired or wireless network gateways, or storage capabilities. These however, are merely a few non-limiting examples of a heterogeneous system of resources that may be utilized to execute a distributed application. It is contemplated that the system of resources may be homogeneous. It is understood that other systems are within the scope of the disclosed subject matter.

In one embodiment, a system of resources may include a variety of current state, or environment, information, such as, for example, central processing unit (CPU) utilization, memory availability, battery level, peripheral component utilization and availability, network bandwidth capacity, and so on. These however, are merely a few non-limiting examples of the current of a state system of resources that may be utilized to execute a distributed application. It is understood that other state information may be examined and are within the scope of the disclosed subject matter.

In one embodiment, the accelerator may utilize a database that details the current configuration and state of the system of resources, as illustrated by block 120. In one embodiment, this database may be referred to as a device and environment database. It is contemplated that this database may be integrated or include a number of various data sources. It is also contemplated that the database may be statically stored, dynamically generated as needed or a combination of the two.

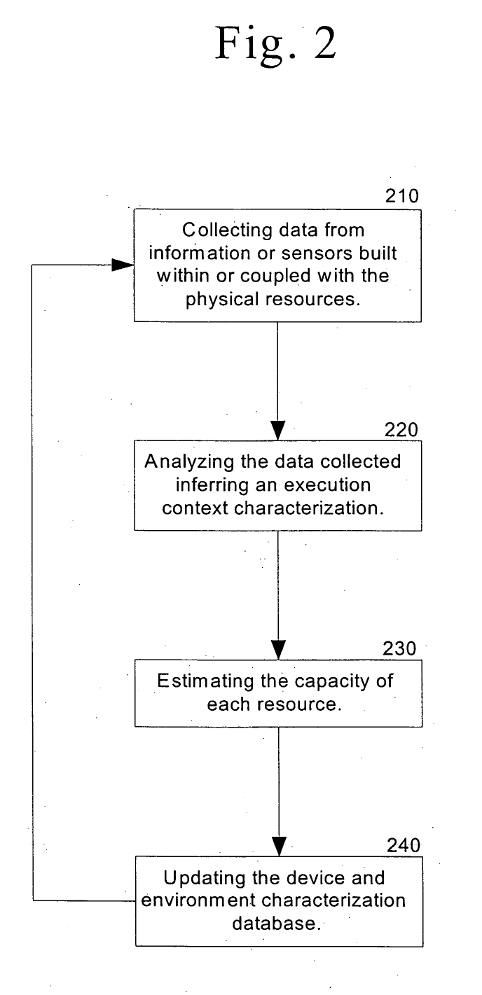

FIG. 2 is a flowchart illustrating an embodiment of a technique for the creation of a device and environment database in accordance with the disclosed subject matter. Block 210 illustrates that data may be collected from identifiers or sensors within the physical system of resources. In one embodiment, the accelerator may determine what processor architecture is being used by reading a processor identifier number associated with the device. In another embodiment, the current battery level of a device may be read. It is contemplated that the information may be generated both dynamically and statically. In addition, it is contemplated that the identifiers and sensors, in some embodiments, may not be within the physical resources, but coupled with the resources or generated by resources in response to a query. However, these are merely a few examples to which the disclosed subject matter is not limited to.

Block 220 illustrates that the collected data may be analyzed in order to infer an execution context characterization. This inferred characterization may provide the accelerator with a description of the context or configuration in which the distributed application will execute. In one embodiment the execution characterization may include information regarding components, such as, for example, model type, battery model, processor architecture, total system memory, firmware, device drivers, etc.; however, these are merely a few illustrative examples to which the disclosed subject matter is not limited by. In another embodiment, the execution characterization may include information regarding the hardware, software, firmware, or any combination thereof of the system on which the distributed application may execute or interact.

Block 230 illustrates that the capacity and capabilities of each device within the system on which the distributed application may execute or interact may be estimated. In one embodiment, the maximum capabilities of the system may be estimated by taking the execution context characterization and assuming no resources are currently used. The current capability may then be estimated by, in one embodiment, utilizing information received as part of block 210. In another embodiment, additional data may be collected from the system. The current capacity may include abilities, such as, for example, battery life, available memory, processor utilization, processor capability, the level of support provided by the device drivers, etc.; however, these are merely a few illustrative examples to which the disclosed subject matter is not limited by. In one embodiment, the estimated capacity may include the current used capacity and any system capacity that has been currently allocated.

Block 240 illustrates that the device and environment characterization database may be updated, or created, utilizing the estimated capacity and inferred execution context characterization. It is contemplated that the database may be stored within a volatile or non-volatile memory. It is further contemplated that the database may be stored in a central local or distributed.

Block 130 of FIG. 1 illustrates that the processing requirements of the application may be determined. In one embodiment, the determined processing requirements may includes requirements, such as, for example, the usage of floating point operations, memory usage, resource requirements, expected usage data, or frequently used network services, etc.; however, these are merely a few illustrative examples to which the disclosed subject matter is not limited by. In one embodiment, the processing requirements may be determined utilizing a content characterization and execution framework analysis.

In one embodiment, the accelerator may utilize a database that details the content characterization and execution framework, as illustrated by block 120. In one embodiment, this database may be referred to as an application characterization database. In one embodiment, the database may include two portions: a static application characterization database, and a dynamic application characterization database. It is contemplated that the application characterization database may be integrated or include a number of various data sources. It is also contemplated that the database may be statically stored, dynamically generated as needed or a combination of the two.

In one embodiment, the static application characterization database may be created substantially during the compilation of the distributed application. It is contemplated that the developer or complier may create a set of meta-data detailing the expected behaviour and resource usage of the application. In one embodiment this static database may be available utilizing the Universal Description Discovery Interface (UDDI) or another service discovery protocol for web services through which companies may find one another to conduct business.

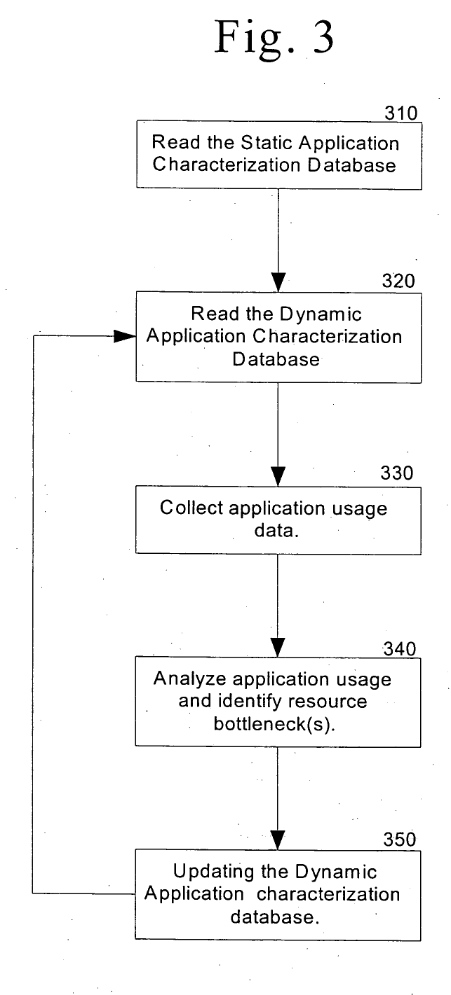

FIG. 3 is a flowchart illustrating an embodiment of a technique for the creation of an application characterization database in accordance with the disclosed subject matter. Block 310 illustrates that the static application characterization database may be read. In one embodiment, the static database may be read from a local source or, conversely, over the network.

Block 320 illustrates that the dynamic application characterization database may be read. In one embodiment, the static database may be read from a local source or, conversely, over the network. It is contemplated that, in one embodiment, during initialization of the application database the dynamic database may be empty. In one embodiment, the dynamic database may include data from a previous execution of the distributed application. In one embodiment, the dynamic database may correlate the data with a by user.

Block 330 illustrates that application usage data may be collected. In one embodiment application usage data may include data such as, for example, user preferences, frequently used network services, frequently used data sources, or profiles of how the application has previously been used; however, these are merely a few illustrative examples to which the disclosed subject matter is not limited by. In one embodiment, the data may be collected from a central database, the user's computer, a number of distributed data source, or a combination thereof.

Block 340 illustrates that the application usage data may be analyzed. In one embodiment, the analysis may identify resource bottlenecks, i.e. areas where the performance of the distributed application will be adversely affected. In one embodiment, the analysis may identify network services that are critical to the performance of the application.

Block 350 illustrates that the dynamic application characterization database may be updated with the most recent usage data, analysis, or both. It one embodiment, the static application characterization database may be included with the dynamic database. In another embodiment, the dynamic application characterization database may not be updated but the application characterization database may be. In one embodiment, the technique of FIG. 3 may be repeated, in whole or part, in order to update the dynamic database in a substantially constant basis.

Block 140 of FIG. 1 illustrates that once the data, regarding the system of resources and the distributed application, have been determined, it may be analyzed in order to attempt to optimize that application performance. In one embodiment, the optimizations may be done per resource platform or using an end-to-end criteria, such as, for example, the application response time as observed by the end-user, power usage, or memory usage; however, other optimizations are contemplated and within the scope of the disclosed subject matter. In one embodiment, examples of optimizations may include: downloading new device drivers to a platform, using a primitive performance library, specifying compiler optimizations for a Just-In-Time (JIT) complier, altering the execution priority of the application during certain stages of execution, dynamically reordering the order in which portions of the application are executed, or altering the quality of data provided by the application; however, these are merely a few illustrative examples and other optimizations are within the scope of the disclosed subject matter.

Block 150 illustrates that these optimizations may be dynamically applied. In one embodiment, the optimizations may be applied utilizing dynamic resource allocation or acceleration tools. In one embodiment, the example optimizations illustrated above may be attempted by, for example, caching or offloading a particular application module or data to a system resource, using an performance primitive library for an appropriate portion of the application execution, utilizing an additional off-loading processing capability to execute the application via locally installed hardware or anther network recourse; however, these are merely a few illustrative examples and other optimizations are within the scope of the disclosed subject matter.

Block 190 illustrates that in one embodiment, the acceleration or chosen optimization of the distributed application may be monitored during execution. The actual optimization results may be compared to the expected optimization results. This empirical data may, in one embodiment, be used to update the device and application databases. The empirical data may also be used to dynamically alter the selected optimizations and attempt to re-optimize the application. In one embodiment, the feedback may be used to adapt to changes in the execution environment of the distributed application. However, the disclosed subject matter is not limited by these illustrative embodiments.

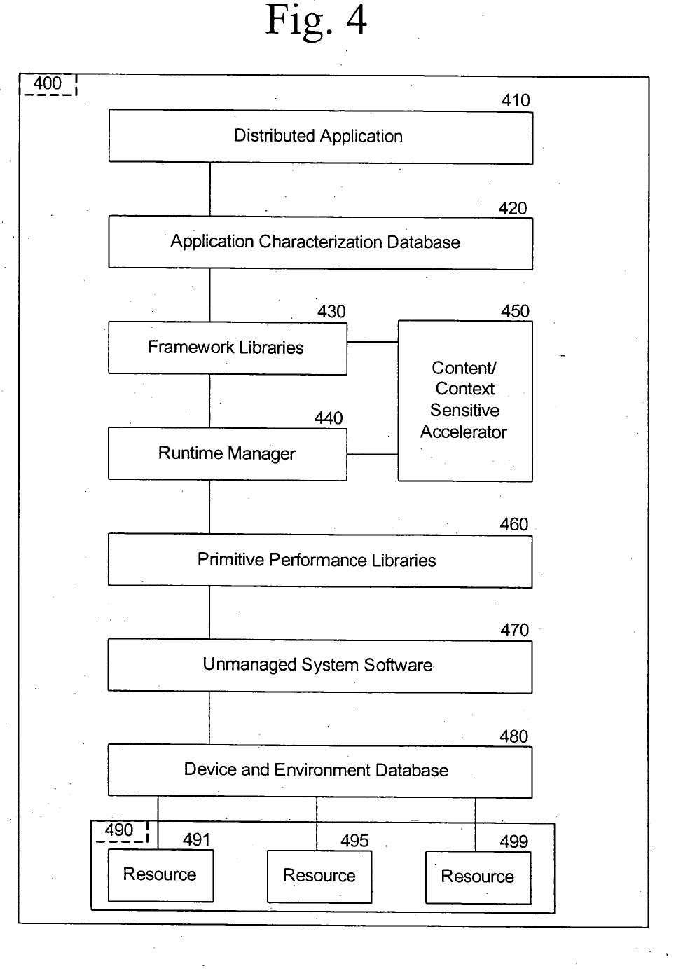

FIG. 4 is a block diagram illustrating an embodiment of a system 400 that allows for the attempted optimization of a distributed application in accordance with the disclosed subject matter. In one embodiment, the system may include a distributed application 410, an application characterization database 420, a content & context sensitive accelerator 450, a device & environment database 480 and a system of resources 490 (illustrated by resources 491, 495, & 499). It is contemplated that the system of resources may include any number or kind of resources and the three illustrated by FIG. 4 are merely one illustrative embodiment of the disclosed subject matter. The distributed application may execute utilizing the system of resources.

In one embodiment, the content & context sensitive accelerator 450 may attempt to optimize execution of the distributed application 410 using a technique described above and illustrated by FIG. 1. The device & environment database 480 may, in one embodiment, be used as illustrated by FIG. 1 and further illustrated by FIG. 2. The application characterization database 420 may, in one embodiment, be used as illustrated by FIG. 1 and further illustrated by FIG. 3. However, other techniques for utilizing and generating the databases are within the scope of the disclosed subject matter.

In one embodiment, the content & context sensitive accelerator 450 may attempt to optimize the execution of the distributed application 410 using the framework libraries 430, the runtime manager 440, the primitive performance libraries 460, and unmanaged system software 470. The framework libraries may include reusable common objects and code modules. The runtime manager may include the managers such as, for example, a operating system, a virtual machine. The primitive performance libraries may include code modules that are optimized for a particular platform or architecture. The unmanaged system software may include software that competes with the application for resources or, in one embodiment, is used by the application. The content & context sensitive accelerator may attempt to optimize execution of the application utilizing a technique described above and illustrated by FIG. 1.

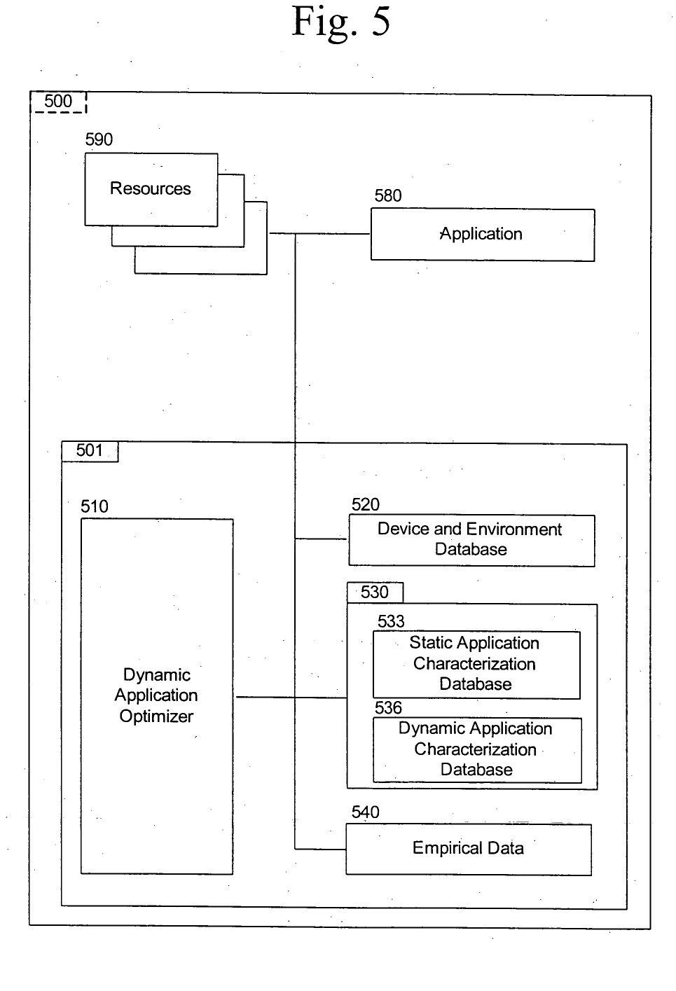

FIG. 5 is a block diagram illustrating an embodiment of an apparatus 501 and a system 500 that allows for the attempted optimization of a distributed application in accordance with the disclosed subject matter. In one embodiment, the apparatus may include a dynamic application optimizer 510, a device & environment database 520, an application characterization database 530, and empirical data 540. It is contemplated that, in one embodiment, the application characterization database may include static application characterization database 533 and dynamic application characterization database 536.

The Dynamic Application Optimizer 510 may be capable of attempting to optimize the execution of distributed application 580 on the system of resources 590. In one embodiment, the Dynamic Application Optimizer may be a dedicated integrated circuit, or, in another embodiment, a generic processing unit. In one embodiment, the Dynamic Application Optimizer may be capable of performing the technique described above and illustrated in FIG. 1. However, these are merely a few illustrative examples to which the disclosed subject matter is not limited by.

The Device & Environment Database 520 may be capable of providing information regarding the system of resources 590 that the application 580 will execute on or interact with. This information may be utilized by-Dynamic Application Optimizer 510 to optimize the application. In one embodiment, the Device & Environment Database may be stored within a volatile memory, a non-volatile memory, or a mixture of the two. Also, it is contemplated that the Device & Environment Database may be centrally located or stored in a distributed fashion. In one embodiment, the Device & Environment Database may be constructed utilizing a technique described above and illustrated by FIG. 2. In one embodiment, the Dynamic Application Optimizer may construct the database. However, in another embodiment, the Device & Environment Database may be constructed, in whole or part, by a separate entity.

The Application Database 530 may be capable of providing information about the architecture of the application 580 and how the application is expected to interact with the system of resources 590. In one embodiment the Application Database may include static application characterization database 533 and dynamic application characterization database 536. This information may be utilized by Dynamic Application Optimizer 510 to optimize the application. In one embodiment, the Application Database may be stored within a volatile memory, a non-volatile memory, or a mixture of the two. Also, it is contemplated that the Application Database may be centrally located or stored in a distributed fashion. In one embodiment, the Application Database may be constructed utilizing a technique described above and illustrated by FIG. 3. In one embodiment, the Dynamic Application Optimizer may construct the database. However, in another embodiment, the Application Database may be constructed, in whole or part, by a separate entity.

The Empirical Data 540 may be capable of providing information about the success, or failure, of the attempted optimization. This information may be utilized by Dynamic Application Optimizer 510 to optimize the application 580. In one embodiment, the Empirical Data may be stored within a volatile memory, a non-volatile memory, or a mixture of the two. Also, it is contemplated that the Empirical Data may be centrally located or stored in a distributed fashion. In one embodiment, the Empirical Data may be constructed utilizing a technique described above and illustrated by FIG. 1. In one embodiment, the Dynamic Application Optimizer may construct and store the data. However, in another embodiment, the Empirical Data may be constructed, in whole or part, by a separate entity.

In one embodiment the system 500 may include a distributed application 580, a system of resources 590 and the apparatus 501. The system of resources may be capable of executing the application. The apparatus may be capable of attempting to optimize the execution of the application of the system of resources. In one embodiment, the system of resources and application may be capable of providing information to the apparatus that facilitates the optimization of the application.

The techniques described herein are not limited to any particular hardware or software configuration; they may find applicability in any computing or processing environment. The techniques may be implemented in hardware, software, firmware or a combination thereof. The techniques may be implemented in programs executing on programmable machines such as mobile or stationary computers, personal digital assistants, and similar devices that each include a processor, a storage medium readable or accessible by the processor (including volatile and non-volatile memory and/or storage elements), at least one input device, and one or more output devices. Program code is applied to the data entered using the input device to perform the functions described and to generate output information. The output information may be applied to one or more output devices.

Each program may be implemented in a high level procedural or object oriented programming language to communicate with a processing system. However, programs may be implemented in assembly or machine language, if desired. In any case, the language may be compiled or interpreted.

Each such program may be stored on a storage medium or device, e.g. compact read only memory (CD-ROM), digital versatile disk (DVD), hard disk, firmware, non-volatile memory, magnetic disk or similar medium or device, that is readable by a general or special purpose programmable machine for configuring and operating the machine when the storage medium or device is read by the computer to perform the procedures described herein. The system may also be considered to be implemented as a machine-readable or accessible storage medium, configured with a program, where the storage medium so configured causes a machine to operate in a specific manner. Other embodiments are within the scope of the following claims.

While certain features of the disclosed subject matter have been illustrated and described herein, many modifications, substitutions, changes, and equivalents will now occur to those skilled in the art. It is, therefore, to be understood that the appended claims are intended to cover all such modifications and changes that fall within the true spirit of the disclosed subject matter.

1: A method comprising:
determining the configuration of a system of resources;
determining the processing requirements of an application running on the system of resources;
analyzing the determined configuration and requirements in order to attempt to optimize the performance of the application;
generating optimization suggestions from the analysis; and
dynamically applying the optimization suggestions.

2: The method of claim 1, wherein dynamically applying the optimization suggestions includes:
dynamically allocating resources to the execution of and interaction with the application; and
dynamically utilizing acceleration tools.

3: The method of claim 2, wherein dynamically utilizing acceleration tools includes utilizing tools selected from a group including:
primitive performance libraries;
managed runtime optimization settings; and
reordering portions of application execution.

4: The method of claim 1, wherein determining the configuration of a system of resources includes utilizing a device and environment characterization database.

5: The method of claim 4, wherein the device database includes information regarding the types of resources in the system of resources and information regarding the physical capabilities of these resources.

6: The method of claim 5, wherein the environment database includes information regarding the configuration, substantially current status, and substantially current capacity of the resources within the system of resources.

7: The method of claim 6, wherein device and environment characterization database is incrementally generated as each of the resources of the system of resources is powered-on.

8: The method of claim 4, wherein the device and environment characterization database is dynamically generated utilizing a service including:
collecting data from sensors coupled with the resources;
analyzing the data collected;
inferring an execution context characterization;
estimating the capacity of each resource; and
updating the device and environment characterization database.

9: The method of claim 1, wherein determining the processing requirements of an application includes utilizing an application characterization database.

10: The method of claim 9, wherein the application characterization database includes:
a static application characterization database that is capable of storing information regarding-fixed characteristics of the application; and
a dynamic application characterization database that is capable of storing information regarding mutable characteristics of the application.

11: The method of claim 10, wherein the static application characterization database is generated utilizing:
determining, by the application's compile time, the data types utilized by the application;
determining, by the application's compile time, the frequency of the usage of the data types;
determining, by the application's compile time, the resource required by the application; and
updating the static application characterization database with the determined information.

12: The method of claim 11, wherein the dynamic application characterization database is generated utilizing:
reading the static application characterization database;
collecting runtime application data usage:
analyzing application usage and identifying resource usage bottlenecks;
updating the dynamic application characterization database.

13: The method of claim 10, further including:
predicting application performance after applying the suggested optimizations;
monitoring the actual application performance to generate empirical data;
comparing the actual application performance to the predicted performance;
performing the method of claim 1, and utilizing the empirical data when analyzing the determined configuration and requirements in order to attempt to optimize the performance of the application.

14. A system comprising:
a distributed application;
a system of resources capable of executing the distributed application;
a Content & Context Sensitive Accelerator capable of attempting to optimize the performance of the distributed application;
a Device & Environment Database capable of providing information to the Content & Context Sensitive Accelerator about the system of resources;
an Application Characterization Database capable of providing information to the Content & Context Sensitive Accelerator about the distributed application; and
unmanaged system software capable of utilizing and the system of resources.

15. The system of claim 14, further including:
a framework library capable of providing a common set of code modules to both the distributed application and the unmanaged system software, and
a runtime manager capable of managing the interaction between the system of resources and any application executing on the system of resources; and wherein the Content & Context Sensitive Accelerator is capable of attempting to optimize by
providing a set of instructions to the runtime manager based, at least in part, upon the information provided by the Device & Environment Database and the Application Characterization Database; and
selecting which portions of the framework library will be utilized by the distributed application.

16. The system of claim 15, further including a primitive performance library capable of providing a set of code modules that are specifically optimized for a particular resource architecture; and
wherein the Content & Context Sensitive Accelerator is further capable of attempting to optimize by
determining that the a first portion of the distributed application is to execute utilizing the framework library and a second portion is to execute utilizing the primitive performance library.

17. The system of claim 14, wherein the Content & Context Sensitive Accelerator is capable of attempting to optimize the performance of the distributed application by:
determining the configuration of a system of resources utilizing the Device & Environment Database;
determining the processing requirements of an application running on the system of resources utilizing the Application Characterization Database;
analyzing the determined configuration and requirements in order to attempt to optimize the performance of the distributed application;
generating optimization suggestions from the analysis; and
dynamically applying the optimization suggestions.

18. The system of claim 17, wherein the Device & Environment Database is capable of being dynamically generated utilizing a service including:
collecting data from sensors coupled with the resources;
analyzing the data collected;
inferring an execution context characterization;
estimating the capacity of each resource; and
updating the device and environment characterization database.

19. The system of claim 18, wherein the Application Characterization Database includes:
a static application characterization database that is capable of storing information regarding fixed characteristics of the distributed application; and
a dynamic application characterization database that is capable of storing information regarding mutable characteristics of the distributed application.

20. The system of claim 19, wherein the static application characterization database is generated utilizing:
determining, by the application's compile time, the data types utilized by the application;
determining, by the application's compile time, the frequency of the usage of the data types;
determining, by the application's compile time, the resource required by the application; and
updating the static application characterization database with the determined information.

21. The system of claim 20, wherein the dynamic application characterization database is generated utilizing:
reading the static application characterization database;
collecting runtime application data usage:
analyzing application usage and identifying resource usage bottlenecks;
updating the dynamic application characterization database.

22. An apparatus comprising:
a Dynamic Application Optimizer capable of attempting to dynamically optimize the performance of an application that is capable of being executed on a system of resources;
a Device & Environment Database capable of providing information to the Dynamic Application Optimizer about the system of resources;
an Application Characterization Database capable of providing information to the Dynamic Application Optimizer about the distributed application; and
empirical data that is capable of providing feedback to the Dynamic Application Optimizer about the success of the attempted optimization.

23. The apparatus of claim 22, wherein the Dynamic Application Optimizer is capable of:
determining the configuration of a system of resources utilizing the Device & Environment Database;
determining the processing requirements of an application running on the system of resources utilizing the Application Characterization Database;
analyzing the determined configuration and requirements in order to attempt to optimize the performance of the application;
generating optimization suggestions from the analysis;
dynamically applying the optimization suggestions;
predicting application performance after applying the suggested optimizations;
monitoring the actual application performance to generate empirical data;
comparing the actual application performance to the predicted performance; and
utilizing the empirical data to attempt improve application performance.

24. The apparatus of claim 23, wherein the Dynamic Application Optimizer is capable of applying the optimization suggestions by:
dynamically allocating portions of the system of resources to the execution of and interaction with the application; and
dynamically utilizing acceleration tools;
wherein the acceleration tools are selected from a group including:
primitive performance libraries:
managed runtime optimization settings; and
reordering portions of the application execution.

25. The apparatus of claim 23, wherein the Device & Environment Database includes:
a device portion having information regarding the types of resources in the system of resources and information regarding the physical capabilities of these resources; and
an environment portion having information regarding the configuration, substantially current status, and substantially current capacity of the resources within the system of resources.

26: The apparatus of claim 23, wherein the Device & Environment Database is capable of being dynamically generated utilizing a service including:
collecting data from sensors coupled with the resources;
analyzing the data collected;
inferring an execution context characterization;
estimating the capacity of each resource; and
updating the device and environment characterization database.

27: The apparatus of claim 26, wherein the application characterization database includes:
a static application characterization database that is capable of storing information regarding fixed characteristics of the application; and
a dynamic application characterization database that is capable of storing information regarding mutable characteristics of the application.

28: The apparatus of claim 27, wherein the static application characterization database is generated utilizing:
determining, by the application's compile time, the data types utilized by the application;
determining, by the application's compile time, the frequency of the usage of the data types;
determining, by the application's compile time, the resource required by the application; and
updating the static application characterization database with the determined information.

29: The apparatus of claim 28, wherein the dynamic application characterization database is generated utilizing:
reading the static application characterization database;
collecting runtime application data usage:
analyzing application usage and identifying resource usage bottlenecks;
updating the dynamic application characterization database.

30: A system comprising:
an application:
a system of resources capable of executing and interacting with the application;
a Dynamic Application Optimizer capable of attempting to dynamically optimize the performance of the application;
a Device & Environment Database capable of providing information to the Dynamic Application Optimizer about the system of resources; and
an Application Characterization Database capable of providing information to the Dynamic Application Optimizer about the distributed application.

31: The system of claim 30, wherein the Dynamic Application Optimizer is capable of:
determining the configuration of a system of resources utilizing the Device & Environment Database;
determining the processing requirements of an application running on the system of resources utilizing the Application Characterization Database;
analyzing the determined configuration and requirements in order to attempt to optimize the performance of the application;
generating optimization suggestions from the analysis; and
dynamically applying the optimization suggestions.

32: The system of claim 31, wherein the Dynamic Application Optimizer is further capable of:
predicting application performance after applying the suggested optimizations;
monitoring the actual application performance to generate empirical data;
comparing the actual application performance to the predicted performance; and
utilizing the empirical data to attempt improve application performance.

33: The system of claim 32, wherein the Dynamic Application Optimizer is capable of applying the optimization suggestions by:
dynamically allocating portions of the system of resources to the execution of and interaction with the application; and
dynamically utilizing acceleration tools;
wherein the acceleration tools are selected from a group including:
primitive performance libraries:
managed runtime optimization settings; and
reordering portions of the application execution.

34: The system of claim 32, wherein the Device & Environment Database includes:
a device portion having information regarding the types of resources in the system of resources and information regarding the physical capabilities of these resources; and
an environment portion having information regarding the configuration, substantially current status, and substantially current capacity of the resources within the system of resources.

35: The system of claim 32, wherein the Device & Environment Database is capable of being dynamically generated by:
collecting data from sensors coupled with the resources;
analyzing the data collected;
inferring an execution context characterization;
estimating the capacity of each resource; and
updating the device and environment characterization database.

36: The system of claim 35, wherein the application characterization database includes:
a static application characterization database that is capable of storing information regarding fixed characteristics of the application; and
a dynamic application characterization database that is capable of storing information regarding mutable characteristics of the application.

37: The system of claim 36, wherein the static application characterization database is generated utilizing:
determining, by the application's compile time, the data types utilized by the application;
determining, by the application's compile time, the frequency of the usage of the data types;
determining, by the application's compile time, the resource required by the application; and
updating the static application characterization database with the determined information.

38: The system of claim 37, wherein the dynamic application characterization database is generated utilizing:
reading the static application characterization database;
collecting runtime application data usage:
analyzing application usage and identifying resource usage bottlenecks;
updating the dynamic application characterization database.

39. The system of claim 37, wherein the system of resources includes a plurality of hardware architectures; and
the application is a distributed application.

40. The system of claim 39, wherein the system of resources includes the Dynamic Application Optimizer.

41: An article comprising:
a storage medium having a plurality of machine accessible instructions, wherein when the instructions are executed, the instructions provide for:
determining the configuration of a system of resources;
determining the processing requirements of an application running on the system of resources;
analyzing the determined configuration and requirements in order to attempt to optimize the performance of the application;
generating optimization suggestions from the analysis; and
dynamically applying the optimization suggestions.

42: The article of claim 41, wherein the instructions providing for dynamically applying the optimization suggestions includes instructions providing for:
dynamically allocating resources to the execution of and interaction with the application; and
dynamically utilizing acceleration tools.

43: The article of claim 42, wherein the instructions providing for dynamically utilizing acceleration tools includes instructions providing for utilizing tools selected from a group including:
primitive performance libraries;
managed runtime optimization settings; and
reordering portions of application execution.

44: The article of claim 41, wherein the instructions providing for determining the configuration of a system of resources includes instructions providing for utilizing a device and environment characterization database.

45: The article of claim 44, wherein the device database includes information regarding the types of resources in the system of resources and information regarding the physical capabilities of these resources.

46: The article of claim 45, wherein the environment database includes information regarding the configuration, substantially current status, and substantially current capacity of the resources within the system of resources.

47: The article of claim 46, wherein the article includes instructions providing for incrementally generating the device and environment characterization database as each of the resources of the system of resources is powered-on.

48: The article of claim 44, wherein the instructions providing for the device and environment characterization database to be dynamically generated utilizing a service including instructions providing for:
collecting data from sensors coupled with the resources;
analyzing the data collected;
inferring an execution context characterization;
estimating the capacity of each resource; and
updating the device and environment characterization database.

49: The article of claim 41, wherein the instructions providing for determining the processing requirements of an application includes instructions providing for utilizing an application characterization database.

50: The article of claim 49, wherein the application characterization database includes:
a static application characterization database that is capable of storing information regarding fixed characteristics of the application; and
a dynamic application characterization database that is capable of storing information regarding mutable characteristics of the application.

51: The article of claim 50, wherein the instructions providing for the static application characterization database include instructions providing for the database's generation utilizing:
determining, by the application's compile time, the data types utilized by the application;
determining, by the application's compile time, the frequency of the usage of the data types;
determining, by the application's compile time, the resource required by the application; and
updating the static application characterization database with the determined information.

52: The article of claim 5 1, wherein the instructions providing for the dynamic application characterization database include instructions providing for generating the database utilizing:
reading the static application characterization database;
collecting runtime application data usage:
analyzing application usage and identifying resource usage bottlenecks;
updating the dynamic application characterization database.

53: The article of claim 50, further including instructions providing for:
predicting application performance after applying the suggested optimizations;
monitoring the actual application performance to generate empirical data;
comparing the actual application performance to the predicted performance;
performing the method of claim 1, and utilizing the empirical data when analyzing the determined configuration and requirements in order to attempt to optimize the performance of the application.

54: A method of reducing energy consumption comprising:
determining the characteristics of a system of resources that an application will execute on;
determining the processing requirements of the application; and
dynamically applying a set of optimizations designed to reduce energy consumption of the application.

55: The method of claim 54, wherein determining the characteristics of a system of resources includes:
determining whether the system of resources is powered either by a limited or a substantially unlimited power supply.

56: The method of claim 55, wherein a limited power supply includes a battery.

57: The method of claim 55, further including, if at least a portion of the system of resources is powered by a limited power supply, estimating how much power remains in the limited power supply.

58: The method of claim 54, wherein determining the characteristics of a system of resources includes utilizing a device and environment characterization database; and wherein determining the processing requirements of the application includes utilizing an application characterization database.

59: The method of claim 54, wherein dynamically applying a set of optimizations includes utilizing tools selected from a group including:
primitive performance libraries;
managed runtime optimization settings;
altering which of the resources of the system of resources executes portions of the application;
altering which of the resources of the system of resources interacts with portions of the application;
altering the data provided by the application;
altering the capabilities of the application; and
reordering portions of application execution.

60: The method of claim 59, further including:
predicting application power usage after applying the set of optimizations;
monitoring the actual application power usage;
monitoring the amount of available power available to the application;
dynamically applying a new set of optimizations if either the available power changes or the actual application power usage is not within a predefined range compared to the predicted application power usage.

61: An article comprising:
a machine readable medium having a plurality of machine accessible instructions, wherein when the instructions are executed provide for:
determining the characteristics of a system of resources that an application will execute on;
determining the processing requirements of the application; and
dynamically applying a set of optimizations designed to reduce energy consumption of the application.

62: The article of claim 61, wherein the instructions providing for determining the characteristics of a system of resources includes instructions providing for:
determining whether the system of resources is powered either by a limited or a substantially unlimited power supply.

63: The article of claim 62, wherein a limited power supply includes a battery.

64: The article of claim 62, further including instructions providing for, if at least a portion of the system of resources is powered by a limited power supply, estimating how much power remains in the limited power supply.

65: The article of claim 61, wherein the instructions providing for determining the characteristics of a system of resources includes instructions providing for utilizing a device and environment characterization database; and
wherein the instructions providing for determining the processing requirements of the application includes instructions providing for utilizing an application characterization database.

66: The article of claim 61, wherein the instructions providing for dynamically applying a set of optimizations includes instructions providing for utilizing tools selected from a group including:
primitive performance libraries;
managed runtime optimization settings;
altering which of the resources of the system of resources executes portions of the application;
altering which of the resources of the system of resources interacts with portions of the application;
altering the data provided by the application;
altering the capabilities of the application; and
reordering portions of application execution.

67: The article of claim 66, further including instructions providing for:
predicting application power usage after applying the set of optimizations;
monitoring the actual application power usage;
monitoring the amount of available power available to the application;
dynamically applying a new set of optimizations if either the available power changes or the actual application power usage is not within a predefined range compared to the predicted application power usage.
